(19) United States
(12) Patent Application Publication
(10) Pub. No.: US 2008/0043673 A1
(43) Pub. Date: Feb. 21, 2008

(54) CELLULAR MOBILE GATEWAY WITH SIGNAL QUALITY INDICATOR

(76) Inventors: Michael D. Johnson, Longmont, CO (US); Noel Sobelman, San Diego, CA (US); Corey Terrell, Escondido, CA (US)

Correspondence Address: KYOCERA WIRELESS CORP., P.O. BOX 928289, SAN DIEGO, CA, 92192-8289, US

(21) Appl. No.: 11/465,772

(22) Filed: Aug. 18, 2006

(51) Int. Cl. H04Q 7/00

(52) U.S. Cl. 370/331

(57) ABSTRACT

An output device in a cellular mobile gateway provides an indication of the signal quality of a cellular communication link between a cellular communication system and the cellular mobile gateway. The cellular mobile gateway includes a local area network (LAN) interface that exchanges data with at least one user device and a cellular transceiver that exchanges the data over a cellular communication link. The output device provides a signal quality indicator based on the quality of a cellular downlink signal received by the receiver in the transceiver.

### BACKGROUND

The invention relates in general to wireless communication systems and more specifically to cellular mobile gateways.

Cellular mobile gateways, also sometimes referred to as cellular routers, mobile routers, and other names, communicate with cellular communication systems and provide packet data services to user devices. Cellular mobile gateways exchange data with wireless user devices and/or wired user devices using a local area network (LAN) interface. The LAN interface may include a wireless LAN (WLAN) transceiver, such as Wi-Fi access point, and/or a wired LAN interface, such as an Ethernet interface, for example. A cellular transceiver within the cellular mobile gateway exchanges the data with a cellular communication system that is typically connected to a public switching system such as a public switched telephone network (PSTN) and/or the Internet. The cellular mobile gateway performs the necessary timing and translation functions to provide data packet service to the users by connecting the LAN to the cellular communication system.

Conventional cellular mobile gateways are limited in that no information is provided regarding the quality of the cellular communication link between the cellular mobile gateway and the cellular communication system. For example, when positioning a cellular mobile gateway at a new location, the installer receives no feedback regarding the relative quality of cellular coverage between two or more potential positions for the cellular mobile gateway. As a result, the installer may place the cellular mobile gateway in a less than optimum location. Further if a conventional cellular mobile gateway is installed in a moving vehicle, there is no indication to the user regarding the changing quality of cellular communication link.

Accordingly, there is a need for an apparatus, system, and method for indicating a signal quality of a cellular communication signal link to a cellular mobile gateway.

### SUMMARY

An output device in a cellular mobile gateway provides an indication of the signal quality of a cellular communication link between a cellular communication system and the cellular mobile gateway. The cellular mobile gateway includes a local area network (LAN) interface that exchanges data with at least one user device and a cellular transceiver that exchanges the data over a cellular communication link. The output device provides a signal quality indicator based on the quality of a cellular downlink signal received by the receiver in the transceiver.

### BRIEF DESCRIPTION OF THE DRAWINGS

FIG. 1 is a block diagram of a cellular mobile gateway within a communication network in accordance with the exemplary embodiment.

FIG. 2 is flow chart of a method of indicating a cellular downlink signal quality in a cellular mobile gateway in accordance with the exemplary embodiment.

### DETAILED DESCRIPTION

In an exemplary embodiment, a cellular mobile gateway (mobile gateway) within a communication network exchanges data with at least one user device and also communicates the data over a cellular communication link with a cellular communication system. The mobile gateway includes an output device that provides indication of the signal quality of the cellular communication link between the cellular communication system and the mobile gateway. The mobile gateway further includes a LAN interface that exchanges the data with the at least one user device and a cellular transceiver that exchanges the data over the cellular communication link. The output device provides the signal quality indication based on the cellular downlink signal received by the receiver in the transceiver.

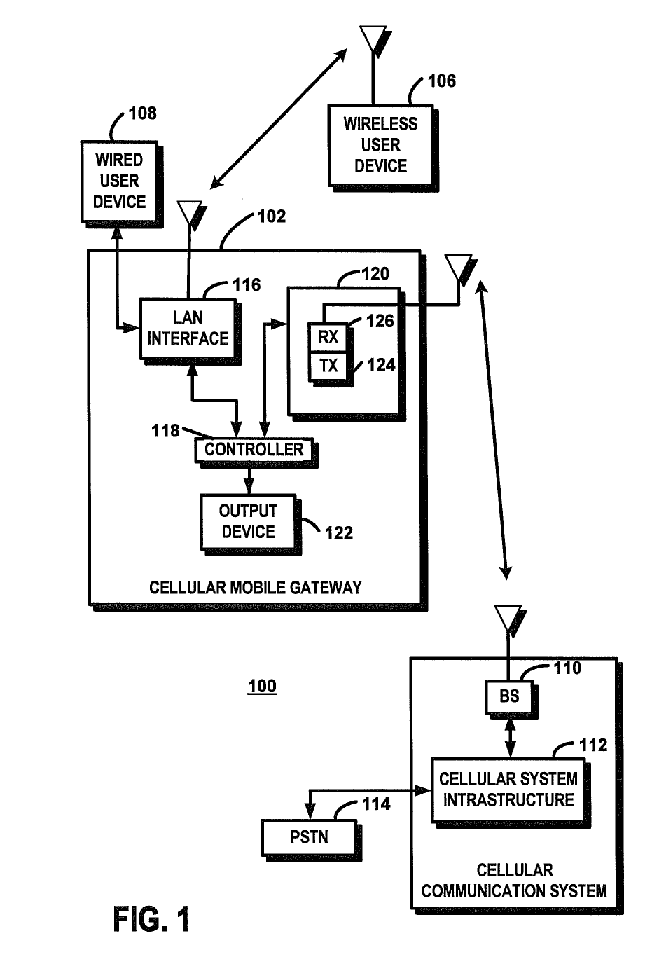

FIG. 1 is a block diagram of a cellular mobile gateway 102 within a communication network 100 in accordance with the exemplary embodiment of the invention. The mobile gateway 102 communicates with a cellular communication system 104 and can exchange data with a wireless user device 106 and/or a wired user device 108. The cellular communication system 104 provides cellular communication services through at least one base station 110 connected to a cellular system infrastructure 112. The cellular system infrastructure 112 is connected to a public switched telephone network (PSTN) 114 through a mobile switching center (MSC) (not shown). In the exemplary embodiment, the cellular communication system 104 operates in accordance Code Division Multiple Access (CDMA) standards such as cdma2000 1×, 1×EV-DO, and W-CDMA. In some circumstances, the cellular communication system 104 may operate with other standards such as OFDM based standards or GSM standards, for example. Accordingly, the cellular communication system 104 is any wireless wide area network (WWAN). The various functions and operations of the blocks described with reference to the cellular communication system 104 may be implemented in any number of devices, circuits, or elements. Two or more of the functional blocks may be integrated in a single device and the functions described as performed in any single device may be implemented over several devices. For example, at least portions of the functions of the cellular system infrastructure 112 may be performed by the base station 110 or the MSC in some circumstances.

The mobile gateway 102 exchanges data with the wireless user device 106 and, in some cases, a wired user device 108 using a LAN interface 116. The mobile gateway 102 further comprises a controller 118 coupled to a cellular transceiver 120, output device 122, and the LAN interface 116. The controller 118, controls the operation and the communication between the transceiver 120, output device 122 and the LAN interface 116 as well as performing other functions and facilitating the overall operation of the mobile gateway 102. The controller 118 receives signal quality information from the cellular transceiver 120 that indicates or is otherwise related to the quality of the communication link between the cellular transceiver 120 and the cellular communication system 104. As described below, the signal quality information may be a parameter such as signal to noise (SNR), or a may be an observed rate of successful transmissions. Based on the signal quality information, the controller 118 generates control signals to control the output device 122. The controller 118 may be connected directly to the output device 122 or may be connected through other circuitry. For example, the controller 118 may be connected to a digital to analog controller (DAC) (not shown) that generates an analog voltage to one or more LEDs.

In the exemplary embodiment, the LAN interface 116 can include a wired LAN interface, a wireless LAN (WLAN) interface or both. The LAN interface 116 may include an interface port (not shown) for exchanging signals with the wired user device 108 in accordance with a wired LAN protocol. An example of a suitable wired LAN protocol includes an Ethernet protocol. Furthermore, a WLAN interface within the LAN interface 116 may include a wireless communication modem exchanging wireless signals with wireless user device 106 in accordance with a WLAN protocol. An example of a suitable WLAN includes a wireless access point that provides packet data service to one or more wireless devices in accordance with federal communications commission (FCC) 802.11 protocol and wireless fidelity (WiFi).

In the exemplary embodiment, the cellular transceiver 120 is an integrated part of the mobile gateway 102 comprising a transmitter 124 and a receiver 126 and is configured to exchange data over a cellular communication link with the cellular communication system 104. The transmitter 124 transmits cellular uplink signals (reverse link signals) to the cellular base station 110 of the cellular communication system 104 and the receiver 126 is configured to receive cellular downlink signals (forward link signals) from the cellular base station 110 through the cellular communication link. In some circumstances, however, the cellular transceiver 120 may not be an integrated part of the mobile gateway 102. As a result, the cellular transceiver 120 may be in a form of a cellular modem card that plugs into and is accepted by a modem port in the mobile gateway 102. The cellular modem card is adapted to exchange data corresponding to the packet data service with the cellular communication system 104 and to receive the cellular downlink signal through the cellular communication link.

The output device 122 is responsive to control signals generated by the controller 118 to indicate a signal quality of at least one cellular downlink (forward link) signal. The controller 118 generates the control signals based on one or more quality indicators provided by the cellular transceiver 120. In the exemplary embodiment, the controller 118 generates signals in accordance with a received signal strength indicator (RSSI) provided by the cellular transceiver 120. The controller 118, however, may use other indicators and combinations of indicators to generate control signals that result in an indication of cellular signal quality when applied to the output device 122. Examples of other signal quality indicators that can be used by the controller 118 include signal to noise (SNR), and data throughput parameters such as bit error rates (BER), total number or successfully received data packets, a percentage of successfully received data packets, and data throughput through the cellular communication link. The controller 118 may also process multiple quality indicators to generate the control signals. For example, the controller 118 may generate control signals based on RSSI and SNR in some situations.

The output device 122 may be any type of visual or auditory output device that is responsive to control signals to indicate the quality of a cellular downlink signal. Therefore, the output device 122 may include one or more light emitting diodes, lights, display screens, liquid crystal displays (LCDs), speakers, or buzzers. For example, the output device 122 can be a single light emitting diode (LED) that is activated at a blinking rate that increases as the cellular downlink signal quality increases. When the cellular downlink signal quality reaches a maximum, the LED stays on continuously and when the signal quality is at a minimum, the LED is turned OFF. In some circumstances, the output device 122 may be an array of LEDs. The cellular downlink signal quality is indicated by the number of the LEDs that stay on such that as a higher number of LEDs stay on, a better signal quality is indicated. In other circumstances, the output device 122 may be in a form of a graphic display and the signal quality can be displayed as the number of bars. Yet in other circumstances, the display can be an array of colors that are displayed such that a red color indicates the lowest signal quality and a green color indicates the maximum signal quality. A single multi-colored LED may be biased to have different colors in accordance with the signal quality level. In the alternative, or in addition to, a visual output device, the output device may include an audio output device. For example, in some circumstances, the signal quality is indicated by audible sounds provided by the output device 122 such that the volume or the frequency of the sound indicates the quality of the cellular downlink signal. In some situations, the output device 122 may include a combination of devices. For example, the output device 122 may include an LED and a speaker. As exaplained above, the control signals may be received directly from the controller 118 or may be received from an intermediary device such as DAC.

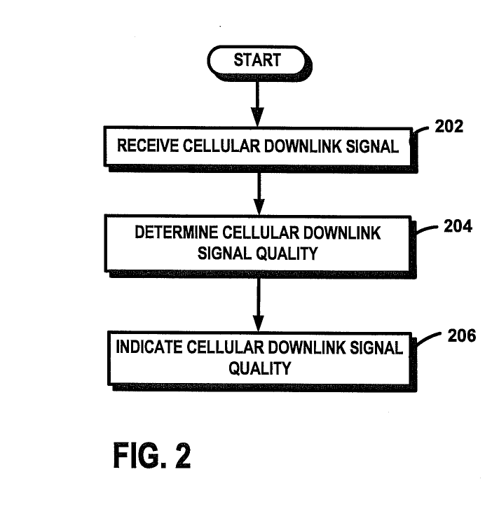

FIG. 2 is flow chart of a method of indicating a cellular downlink signal quality in a cellular mobile gateway in accordance with the exemplary embodiment. Although the method may be performed by any combination of hardware, software, and/or firmware or in any of numerous devices, the method is executed by the controller 118 in the cellular mobile gateway 102.

At step 202, the receiver 126 receives a cellular downlink signal from the cellular communication system 104. In the exemplary embodiment, the receiver 126 demodulates a pilot signal transmitted by a base station 110. In some situations the receiver 126 may comprise a detector that determines the power within a particular channel without demodulating or decoding a specific signal within the channel.

At step 204, the controller 118 determines the cellular downlink signal quality received by the receiver 126. Based on the quality indicator provided by the cellular transceiver 120, the controller 1 18 generates control signals that when applied to the output device 122, results in an indication of the quality of the cellular downlink signal. In the exemplary embodiment, a received signal strength indicator (RSSI) is generated based on the received signal. Any of numerous methods, however, may be used to generate a signal quality indicator based on the received signal as described above.

At step 206, the output device 122 in response to the control signals from the controller 118 indicates the cellular downlink signal quality by displaying the signal quality in an audio and/or visual format. In the exemplary embodiment, a set of LEDs are activated in accordance with the signal quality determined by the controller 118. As explained above, any of numerous output devices and combinations of output devices may be used to display the signal quality.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A cellular mobile gateway comprising:
a local area network (LAN) interface configured to exchange data with at least one user device;
a cellular transceiver configured to exchange the data over a cellular communication link and comprising a receiver configured to receive a cellular downlink signal from a cellular communication system; and
an output device configured to indicate a signal quality of the cellular downlink signal.

2. The cellular mobile gateway of claim 1, wherein the output device is configured to indicate a signal strength of the cellular downlink signal.

3. The cellular mobile gateway of claim 1, wherein the output device is configured to indicate a data throughput through the cellular communication link.

4. The cellular mobile gateway of claim 1, wherein the output device comprises a light emitting diode (LED).

5. The cellular mobile gateway of claim 1, wherein the LAN interface comprises an interface port exchanging signals in accordance with a wired local area network (LAN) protocol.

6. The cellular mobile gateway of claim 5, wherein the wired LAN protocol is an Ethernet protocol.

7. The cellular mobile gateway of claim 1, wherein the LAN interface comprises a wireless communication modem exchanging wireless signals in accordance with a wireless local area network (LAN) protocol.

8. The cellular mobile gateway of claim 7, wherein the wireless LAN protocol is in accordance with a federal communications commission (FCC) 802.11 protocol.

9. A cellular mobile gateway comprising:
a local area network (LAN) interface configured to provide packet data service to at least one user device;
a cellular modem port configured to accept a cellular modem card configured to exchange data corresponding to the packet data service with a cellular communication system and to receive a cellular downlink signal through a cellular communication link;
an output device configured to indicate a signal quality of the cellular downlink signal.

10. The cellular mobile gateway of claim 9, wherein the output device is configured to indicate a signal strength of the cellular downlink signal.

11. The cellular mobile gateway of claim 9, wherein the output device is configured to indicate a data throughput through the cellular communication link.

12. The cellular mobile gateway of claim 9, wherein the output device comprises a light emitting diode (LED).

13. The cellular mobile gateway of claim 9, wherein the LAN interface comprises a interface port exchanging signals in accordance with wired a local area network (LAN) protocol.

14. The cellular mobile gateway of claim 13, wherein the wired LAN protocol is an Ethernet protocol.

15. The cellular mobile gateway of claim 9, wherein the LAN interface comprises a wireless communication modem exchanging wireless signals in accordance with a wireless local area network (LAN) protocol.

16. The cellular mobile gateway of claim 15, wherein the wireless LAN protocol is in accordance with a federal communications commission (FCC) 802.11 protocol.

17. A cellular mobile gateway comprising:
a wireless local area network (LAN) modem configured to exchange data with a plurality of wireless devices;
a cellular transceiver configured to exchange the data over a cellular communication link by transmitting cellular uplink signals to a cellular base station and receiving cellular downlink signals from the cellular base station; and
an output device configured to indicate a signal quality of at least one cellular downlink signal based on an indicator provided by the cellular transceiver.

18. The cellular mobile gateway of claim 17, wherein the output device is configured to indicate a signal strength of the cellular downlink signal.

19. The cellular mobile gateway of claim 17, wherein the output device is configured to indicate a data throughput through the cellular communication link.

20. The cellular mobile gateway of claim 17, wherein the output device comprises a light emitting diode (LED).
